(19) United States
(12) Patent Application Publication
(10) Pub. No.: US 2026/0217368 A1
(43) Pub. Date: Jul. 30, 2026

(54) SYSTEMS, METHODS, AND DEVICES FOR REACTIONLESS CYCLIC ROTORS

(71) Applicant: Supernal, LLC, Irvine, CA (US)

(72) Inventors: Carmela VALLALTA, Long Beach, CA (US); Maurice GRIFFIN, Corpus Christi, TX (US); Evan FEIL, Shelton, CT (US)

(73) Assignee: Supernal, LLC, Irvine, CA (US)

(21) Appl. No.: 19/147,452

(22) PCT Filed: Jan. 10, 2024
(86) PCT No.: PCT/US2024/011002

§ 371 Date: Jul. 11, 2025

Related U.S. Application Data
(60) Provisional application No. 63/479,967, filed on Jan. 13, 2023.

(51) Int. Cl. B64C 27/605; B64C 27/72

(52) U.S. Cl. CPC B64C 27/605; B64C 27/72

(57) ABSTRACT

A rotor assembly includes a rotor mast, motor, and a rotor hub. The rotor mast may connect to the motor and to the rotor hub. The rotor mast may be rotatable about a first axis. A plurality of blades may be connected to the rotor hub. The rotor hub may include a shaft that may connect the blades. A swashplate may connect to the rotor mast and to the shaft. A single linkage may extend from a first end to a second end, the first end may be coupled to the shaft and the second end may be coupled to the swashplate. The single linkage may be configured to transfer motion of the swashplate to rotate the shaft about the second axis and thereby rotate the blades about the second axis simultaneously.

### CROSS REFERENCE TO RELATED APPLICATIONS

This application is the U.S. national phase entry under 35 U.S.C. § 371 of, and claims priority to, International Application No. PCT/US2024/011002, filed Jan. 10, 2024, which claims priority on U.S. Provisional Application No. 63/479,967, filed Jan. 13, 2023.

### TECHNICAL FIELD

The present disclosure relates to rotor systems for vertical takeoff and landing vehicles. In particular, the present disclosure relates to rotor assemblies that are incorporated in vertical takeoff and landing vehicles.

### BACKGROUND OF THE INVENTION

A variety of vehicles use a rotor or a proprotor to generate thrust and propel the vehicle, including for example, aircraft (e.g., air mobility vehicles). Air mobility includes the use of aircraft for commuting activities traditionally accomplished using an automobile. Air mobility has been highlighted as an effective means of transportation to resolve traffic congestion and reduce environmental pollution in areas where automobile use is very high, such as in cities.

Modern air mobility vehicles (AMVs) and other types of aircraft are very sophisticated. These vehicles implement multi-level integrated computing systems to control complex electro-mechanical devices and sophisticated device assemblies to automate various functions of aircrafts and assist pilots during flight. For example, electric vertical takeoff and landing (eVTOL) vehicles, which may be used as AMVs, employ distributed propulsion systems (DEPs) that include several rotor assemblies, as well as multiple types of rotor assemblies (e.g., tilting, non-tilting, proprotors, or lifting rotor assemblies).

Proprotors may refer to spinning airfoils that function both as an airplane-style propeller and a helicopter-style rotor. Aircraft, for example, can include general categories of horizontal thrust aircraft (e.g., fixed wing aircraft) and vertical thrust aircraft (e.g., helicopters), or a combination of the two (such as a “vertical take off and landing” or “VTOL”). Vehicles that utilizes a propeller or proprotor use rotor hubs to control and transfer power to the propeller rotor or proprotor.

Different types of rotor and proprotors present different issues and advantages. For example, some rotor assembly systems have a hub assembly that includes a pitch horn for each blade. The pitch horns connect to a respective swashplate of the rotor assembly to each individual blade. Having a pitch horn for each blade can lead to additional stresses on the hub assembly, and can create drag, increase vibrations, and add weight. Further, the use of individual pitch horns for each blade can result in less accurate adjustments of the blades during cyclic movement of a rotor assembly.

Some conventional rotor assemblies also experience issues when used in an AMV or other vehicle with multiple rotor assemblies. For example, some hubs struggle to adjust for changes in lift across the different rotors of a vehicle. This can create oscillations in the vehicle that increase mechanical stresses on the vehicle which may lead to a shorter lifespan of the vehicle or create extra maintenance costs.

Thus, there is a need for efficient, scalable, safe, easily manufactured, and economically-feasible rotor assembly to be utilized in vertical take-off and landing craft that are suited to efficiently generate horizontal thrust capability at speed, as well as to take off and land with minimal infrastructure requirements. There is also demand for such a rotor assembly that has minimal components to reduce drag, weight, and mechanical stresses.

The present disclosure is accordingly directed to rotor assemblies that can be incorporated in AMVs such as eVTOLs. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Examples described herein include devices, systems, and methods directed toward rotor assemblies. The rotor assemblies may include one or more of the following features: a rotor mast connected to a motor and to a rotor hub, the rotor mast being rotatable about a first axis; a plurality of blades connected to the rotor hub; the rotor hub including a shaft connecting the blades, the shaft being rotatable about a second axis; a swashplate connected to the rotor mast and to the shaft; and a single linkage extending from a first end to a second end, the first end being coupled to the shaft, the second end being coupled to the swashplate, the single linkage configured to transfer motion of the swashplate to rotation of the shaft about the second axis and thereby rotate the plurality of blades about the second axis simultaneously.

Various aspects of exemplary devices, systems, and methods according to the present disclosure may include one or more of the following features: the first end of the single linkage is formed on a pitch link and the second end of the linkage is formed on a control rod; the pitch link is coupled to the shaft at a center-most point of the shaft; a first end of the pitch link is generally cylindrical and includes an aperture configured to receive the shaft, wherein the first end of the pitch link forms the first end of the linkage; a second end of the pitch link, opposite of the first end of the pitch link, is coupled to the control rod, the second end of the pitch link is configured to pivot when lifted or lowered by the control rod; the shaft is configured to decrease a first angle of attack of a first blade and increase a second angle of attack of a second blade simultaneously. The rotor assembly may further include a first actuator and a second actuator that are each configured to move the swashplate; and the shaft is connected to the rotor mast by two yoke protrusions, the first end of the linkage being disposed between the two yoke protrusions.

In another example, an exemplary rotor assembly according to the present disclosure may include a rotor mast connecting a motor to a rotor hub, the rotor mast being rotatable about a first axis that extends through the rotor mast; at least two blades connected to the rotor hub; a shaft connecting the at least two blades, the shaft being rotatable about a second axis; a control rod; a swashplate connected to the shaft by the control rod; and a pitch link connected to the shaft at a center of the shaft as measured along the second axis, the pitch link being configured to rotate the shaft around the second axis and thereby change an angle of attack of the at least two blades simultaneously.

Various aspects of exemplary devices, systems, and methods according to the present disclosure related to rotor assemblies may include one or more of the following features: the shaft is a single shaft that passes through a center of the rotor assembly as measured along the second axis; the control rod is connected to the shaft by the pitch link; a first end of the pitch link is generally cylindrical and includes an aperture configured to receive the shaft; the pitch link extends towards the control rod in a direction perpendicular to the second axis; and the shaft is connected to the rotor hub by two yoke protrusions, the pitch link being disposed between the two yoke protrusions.

In another example, a vehicle according to the present disclosure may include a first rotor assembly including: a first set of at least two blades; a first shaft connected to the first set of at least two blades, the first shaft being rotatable about a first axis; and a first pitch link connected to the first shaft at a center of the first shaft as measured along the first axis and configured to rotate the first shaft along the first axis and thereby change an angle of attack of the first set of at least two blades and a second rotor assembly including: a second set of at least two blades; a second shaft connected to the second set of at least two blades, the second shaft being rotatable about a second axis; and a second pitch link connected to the second shaft at a center of the second shaft as measured along the second axis and configured to rotate the second shaft along the second axis and thereby change an angle of attack of the second set of at least two blades.

Various aspects of exemplary devices, systems, and methods according to the present disclosure related to vehicles may include one or more of the following features: the first rotor assembly includes a first swashplate connected to the first shaft by a first control rod, and the second rotor assembly includes a second swashplate connected to the second shaft by a second control rod; the first control rod is connected to the first shaft by the first pitch link, and the second control rod is connected to the second shaft by the second pitch link; wherein a first end of the first pitch link defines a cylindrical aperture configured to receive the first shaft, wherein a first end of the second pitch link defines a cylindrical aperture configured to receive the second shaft; the first set of the at least two blades are configured to be rotated by the connection to the first swashplate every revolution and the second set of the at least two blades are rotated by the connection to the second swashplate every revolution; and the first shaft is configured to decrease a first angle of attack of a first blade of the first set of at least two blades and increase a second angle of attack of a second blade of the first set of at least two blades simultaneously; and the second shaft is configured to decrease a third angle of attack of a third blade of the second set of at least two blades and increase a fourth angle of attack of a fourth blade of the second set of at least two blades simultaneously.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary air mobility vehicle (“AMV”), according to one or more embodiments.

FIG. 2 depicts an exemplary rotor assembly, according to one or more embodiments.

FIG. 3A depicts an exemplary rotor assembly of FIG. 2, according to one or more embodiments.

FIG. 3B depicts an overhead view of the rotor assembly of FIG. 3A, according to one or more embodiments.

FIG. 3C depicts a cross-sectional view of the rotor assembly of FIG. 3A, from a plane corresponding to line 3C-3C of FIG. 3B.

FIG. 3D depicts a cross-sectional view of the swashplate assembly of FIG. 2, from a plane corresponding to line 3C-3C of FIG. 3B.

FIG. 4 depicts an exemplary rotor assembly, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for providing rotor assemblies for AMVs.

Some aircraft may include one or more blades capable of being positioned in a substantially vertical orientation that allows the aircraft to achieve vertical take-off or remain flying (e.g., providing vertical lift). In such aircraft, loads created by the rotation of the blade may be transferred to the airframe through a hub assembly. Portions of the hub assembly may rotate with the blades, and portions of the hub assembly may remain stationary.

A swashplate may convert flight maneuver input from a pilot into a motion of rotor blades so that, at the same time: (1) an angle of attack of an advancing blade can be reduced, and (2) an angle of attack of a retreating blade can be increased, to balance out the lift generated by the advancing blade. The swashplate may convert control inputs from, for example, the pilot, into rotating inputs which can be connected to the rotor blades or control surfaces. Swashplates may be controlled by one or more actuating devices that change the pitch of rotor blades collectively and/or cyclically. For example, a pilot and/or one or more electronic control systems (also referred to herein as a “controller”) of a vehicle may utilize cyclic controls to adjust an AMV's roll or pitch. The cyclic controls may adjust, for example, actuators that tilt the swashplate. The tilt of the swashplate may then cause a pitch horn and control rod to rotate the angle of the blade and cause pitch or roll for the vehicle. A swashplate may require frequent checks and maintenance to ensure respective structural and operational integrity, and generally increase a complexity of a rotor assembly. Some swashplate designs are complex and include many components that make for a heavy assembly to go with the above-mentioned linkages that may also be of substantial weight.

As stated, some rotor hubs may include a pitch horn and control rod for each rotor. Including a pitch horn and control rod for each blade of a vehicle may increase the suspended weight of the vehicle. Suspended weight that is spaced away from the rotor mast may create stresses that should be compensated by more connecting structure. Some hubs assemblies may also struggle to adjust for change in lift across different rotors of a vehicle, creating oscillations in a vehicle structure that threaten to harm the vehicle.

Exemplary disclosed embodiments include devices, systems, and methods for rotor hubs for vehicles. In some embodiments, the vehicles may be aircraft capable of vertical take-off and landing. In some embodiments, the vehicles may include a rotor including at least two blades. The blades may be configured to generate vertical lift. The blades may be attached to the vehicle by a shaft. The shaft may include one or more components that are rotatable about an axis that is different than a “primary” axis about which the blades rotate to generate propulsion. The shaft may be configured to rotate when a pitch link rotates. The shaft may: (1) cause a rotation of the blades around a shaft mast in a first axis that is different from the primary axis, (2) change position with respect to a second axis (e.g., the primary axis), adjusting the angle of attack of the blades at corresponding angles, and (3) rotate itself around the second axis (e.g., the primary axis). The shaft may be connected to the vehicle by a single pitch link and a single control rod to a swashplate. The pitch link may be configured to position the shaft about a second axis in response to tilting of the swashplate. As the shaft rotates around the first axis, based on the tilt of the swashplate, the shaft itself may rotate along the second axis throughout a single rotation of the shaft around the first axis. Throughout this rotation, the angle of attack of the blades may change as the shaft rotates around the first axis. This adjustment to the angle of attack may be caused by the pitch link rotating the shaft at various degrees throughout the rotation of the shaft along the first axis.

Consistent with disclosed embodiments, the vehicle may include one or more rotors. The vehicle may be an aircraft. Some non-limiting examples of an aircraft may include a vertical take-off and landing craft, a helicopter, a quadrotor, an airship, an airplane, an unmanned aerial vehicle, or a drone. In some embodiments, rotor assemblies may be used without collective control. For example, collective control may not be utilized, in at least some embodiments, as the hubs may be configured to change the pitch direction of the blades equally and in opposite directions. The total thrust may be modulated by varying the rotation speed (e.g., as measured in rpm) of the motor driving the rotor.

Various embodiments of the present disclosure relate generally to systems and methods for providing rotor assemblies for AMVs, such as eVTOLs, that reduce weight and space requirements for a hub along with reducing drag. The exemplary rotor may further lead to more efficient load transmission, for aircraft using rotors or proprotors. For example, the design of the hub may reduce aerodynamic moments that are generated by airflow crossing the rotor plane in the in-plane direction.

One or more embodiments may include a hub assembly that utilizes less components, the less components leading to a reduction in weight (e.g., suspended weight) and space requirements along with drag. Less components may further lead to reduced maintenance and costs. Reduced weight of the hub assembly may further reduce vibrations to a rotor mast. This may further reduce the number of components used to generate propulsion, for example, to reduce maintenance and replacement costs.

One or more embodiments has the ability to efficiently adjust an angle attack of the blades. Adjusting the angle of attack of two blades in a blade pair may, for example, provide more accurate cyclic controls. The system may be capable of adjusting the angle of attack of blades using a single pitch link and control rod. Thus, each blade may not require a separate pitch link and rotation of a single shaft may simultaneously adjust the angles of attack for a plurality of blades.

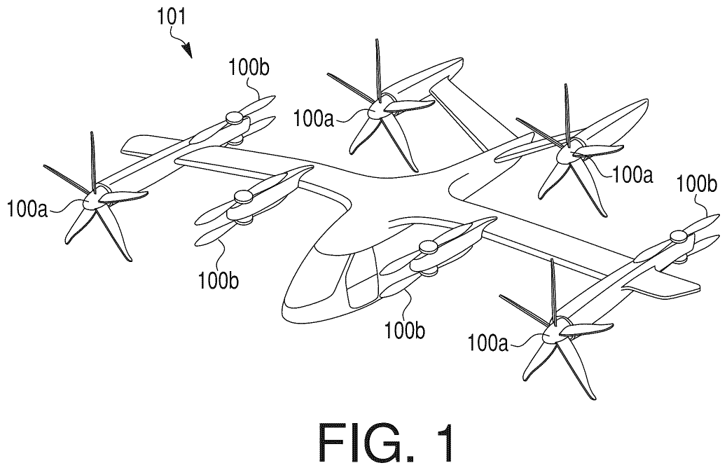

FIG. 1 depicts an exemplary AMV 101, according to one or more embodiments. The AMV 101 may include exemplary rotor assemblies 100a, 100b. The rotor assemblies 100a, 100b may correspond to any of the rotor assemblies 100, 200, or 300 described herein. In some examples, the AMV 101 may be a vertical take-off and landing (VTOL) vehicle, a helicopter, other aircraft, or any other type of vehicle that would benefit from the use of the rotor assemblies described herein. Rotor assemblies 100a may be proprotors that are positionable from a generally vertical orientation for take-off and landing to a generally horizontal orientation (e.g., for cruise as shown). Rotor assemblies 100b may assist during take-off or landing of AMV 101, and also assist in keeping the AMV 101 airborne at a desired altitude, rate of ascent, or controlled rate of descent, during flight.

The rotor assemblies 100a, 100b may for example receive commands in response to cyclic controls within the AMV 101. The cyclic controls may be generated by a user interacting with control devices within a cockpit of the AMV 101 and/or by a controller.

Exemplary rotor assemblies according to the present disclosure, including the rotor assemblies 100a, 100b, may leverage a variable speed rotor connected to an electric motor to vary thrust with exemplary hub assemblies described herein, to create cyclic pitch that may reduce vibratory forces and moments resulting in reduced system weight and a smoother ride for passengers. Accordingly, cyclic control may be applied to the exemplary rotor assemblies, described herein. The cyclic controls may provide a method of reducing loads on each rotor assembly 100a, 100b and improve overall performance of the AMV 101.

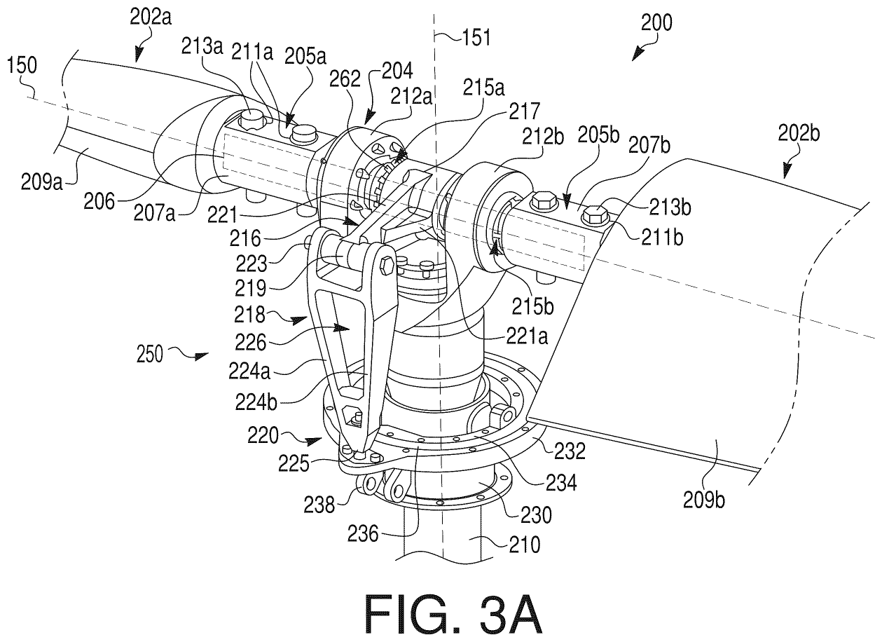

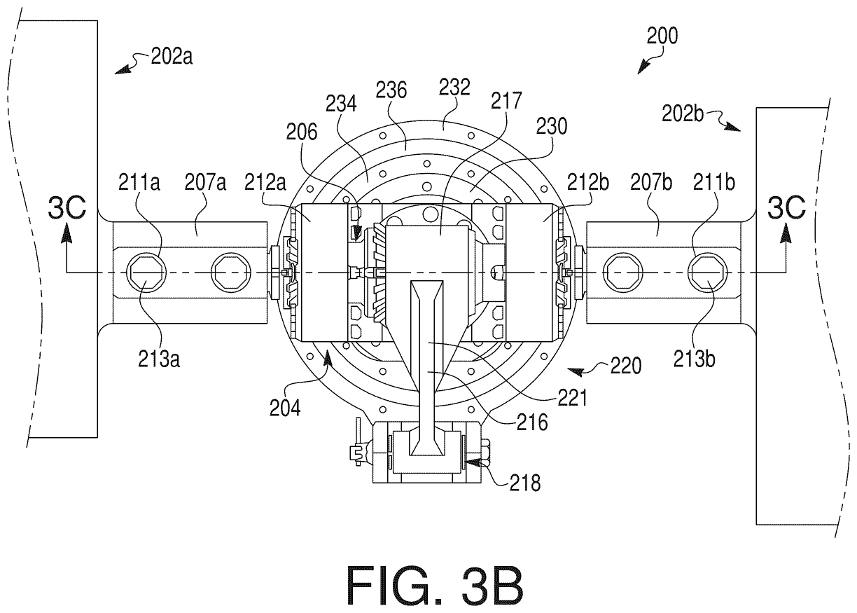

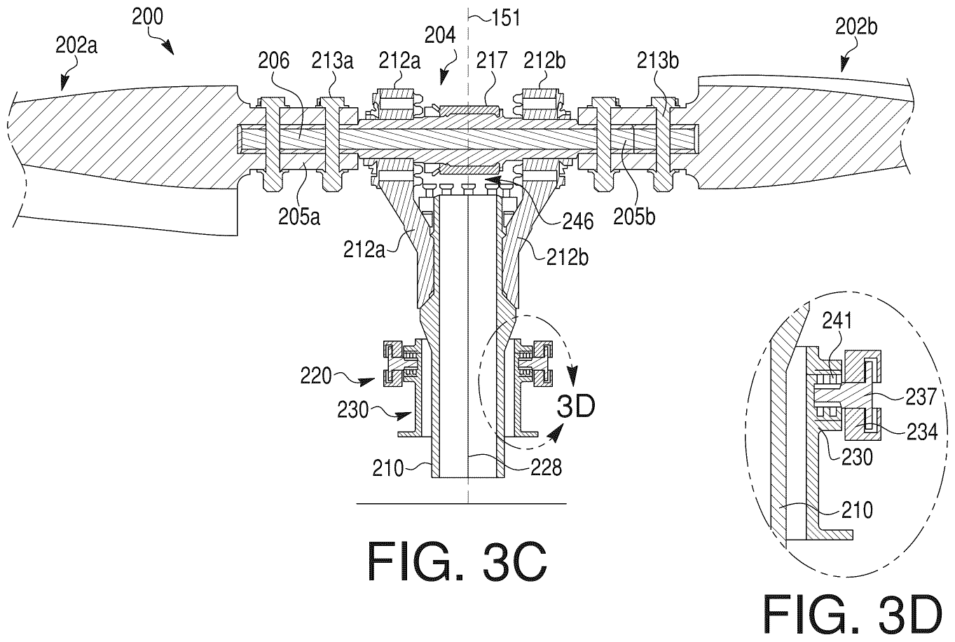

In some embodiments where a vehicle comprises more than one rotor assembly 100a, 100b, an oscillation stress on the vehicle caused by lift disparity of different forces on different rotor hub assemblies can be reduced by actuating swashplate (e.g., the swashplate 220 of FIG. 3A) of one or more rotor hub assemblies.

Rotor assemblies (e.g., rotor assembly 100a and/or rotor assembly 100b) consistent with disclosed embodiments may be connected to fixed speed or variable speed motors. In some embodiments, thrust may be adjusted to maneuver a vehicle (e.g., different speeds for different rotors/rotor assemblies of a vehicle to change a direction of travel). In some embodiments, an electric motor can be used as a variable speed motor to power the rotor assemblies.

For example, as will be discussed in greater detail below, a shaft within a rotor assembly (e.g., rotor assembly 100a and/or rotor assembly 100b) may be configured to rotate and increase the angle of attack for a first blade of a blade pair by a particular angle and decrease the angle of attack of a second blade of the blade pair by the same angle. Further, alternative rotor assemblies (e.g., rotor assembly 100a and/or rotor assembly 100b) of the vehicle may adjust their corresponding blade pitch at an angle independent of other rotor assemblies on the vehicle, allowing for independent control of the angles of attack for two or more rotor assemblies. For example, when adjusting the shaft (e.g., the angle of attack) for a first rotor assembly, this may create a lift disparity between the first rotor assembly and any additional rotor assemblies.

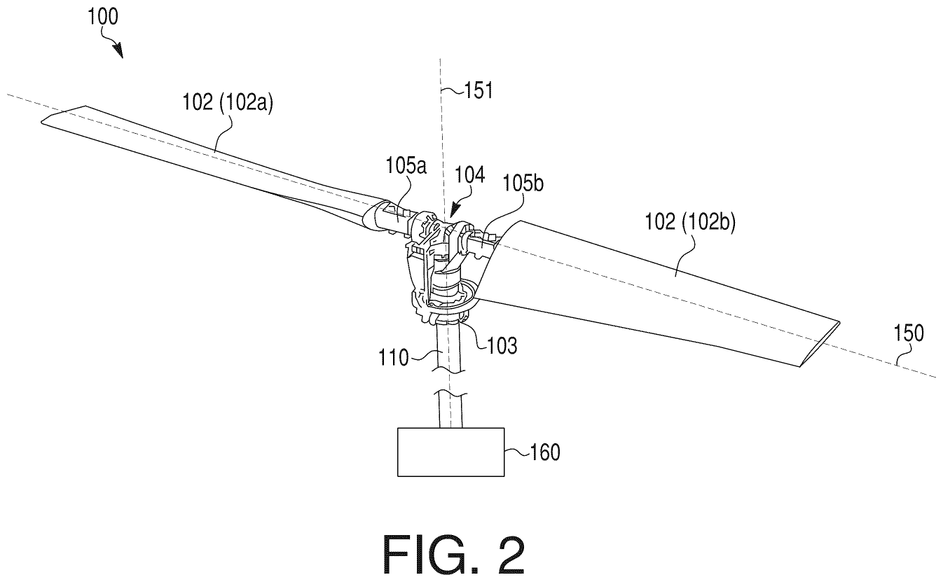

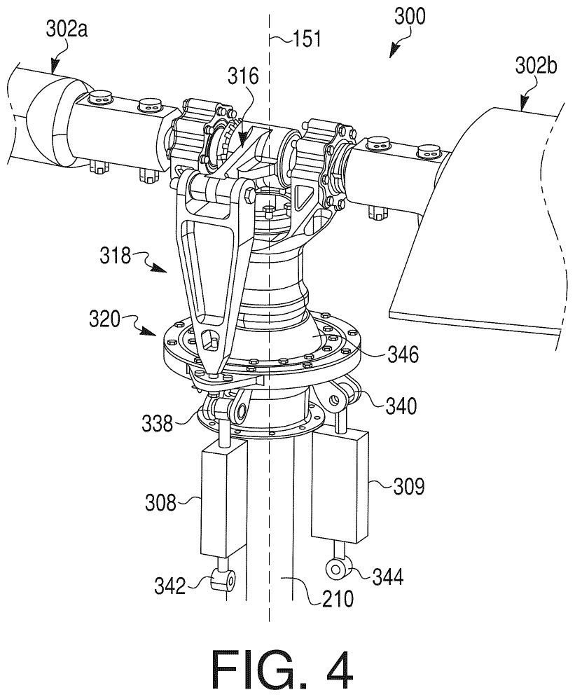

FIG. 2 depicts an exemplary rotor assembly 100, according to one or more embodiments. As shown in FIG. 2, the rotor assembly 100 may include a blade pair 102, a hub assembly 104, a rotor mast 110, and one or more actuators (e.g., a first actuator 308 and a second actuator 309 illustrated in FIG. 4). Portions of the rotor assembly 100 may rotate (e.g., the blade pair 102, the rotor mast 110, and portions of the hub assembly 104) in order to generate thrust. In some examples, the one or more actuators may include a hydraulic actuator or an electric motor. In still other examples, the actuator may include a pneumatic actuator.

The blade pair 102 may include a first rotor blade 102a and a second rotor blade 102b. The rotor assembly 100 may include a first coupling 105a configured to operatively couple the first rotor blade 102a to the hub assembly 104. The rotor assembly 100 may include a second coupling 105b configured to operatively couple the second rotor blade 102b to the hub assembly 104. The first coupling 105a and second coupling 105b may connect the respective rotor blades to a shaft within the hub assembly 104 (e.g., a shaft 206 illustrated in FIG. 3C). The first coupling 105a and second coupling 105b are illustrated in FIG. 3C and will be described in greater detail below.

The first rotor blade 102a and second rotor blade 102b may be in the shape of an airfoil. As the first rotor blade 102a and second rotor blade 102b extend away from the hub assembly 104, the shape of the blades may twist along the first axis 150. The first axis 150 may be defined by the direction of the shaft (e.g., the shaft illustrated in FIG. 3C). Further, the surface area of the blade pair 102 may decrease as the blade extends further from the hub assembly 104. Additionally, a thickness of the blade pair 102 may decrease as the blades extend further from the hub assembly 104.

While a blade pair 102 is shown in FIG. 2, some embodiments may include four blades. For example, the hub assembly 104 may include two blade pairs 102 may where each blade pair 102 includes two blades and the blade pairs are located ninety degrees apart of the first axis 150 and perpendicular to the second axis 151. Further, in this example, each blade pair 102 may include a separate connecting link as described in FIG. 2. In still other examples, the blade pair 102, may be a monolithic blade pair and thereby provide a one-piece structure that includes two blades connected monolithically with a common shaft. While the blades of the blade pair 102 are illustrated in FIG. 2 as having a particular shape, a person of ordinary skill in the art would understand that other blade shapes are envisioned.

The hub assembly 104 may include a third coupling 103 that operatively couples a portion of the hub assembly 104 to the rotor mast 110. This third coupling 103 may be, for example an interior ring 230 as illustrated in FIG. 3A. The third coupling 103 may secure portions of the hub assembly to the rotor mast 110. The third coupling 103 may enable rotation of the hub assembly 104 along a second axis 151 as the rotor mast 110 is rotated along the second axis 151. As the hub assembly 104 rotates along the second axis 151, the hub assembly may cause the rotation of the blade pair 102 around the second axis 151 through the first coupling 105a and second coupling 105b. The second axis 151 may be an axis that extends centrally through the blade pair 102 from the first rotor blade 102a to the second rotor blade 102b.

The hub assembly 104 may include a shaft (e.g., a shaft 206 illustrated in FIG. 3C). The shaft may extend from the first rotor blade 102a to the second rotor blade 102b and connect to the blade pair 102 at the first coupling 105a and second coupling 105b respectively. The shaft of the hub assembly 104, as will be described in greater detail below, may be rotated about the first axis 150 by other components in the hub assembly 104 (e.g., by the pitch link 216 and control rod 218 illustrated in FIG. 3A). This rotation of the shaft along the first axis 150 may cause the blade pair 102 to rotate to decrease or increase an angle of attack of the blade pair 102 relative to the first axis 150. As the first rotor blade 102a and second rotor blade 102b are coupled through the shaft, the rotation of the shaft may lead to corresponding angle of attack adjustments between the two blades. For example, if the shaft is rotated fifteen degrees by the hub assembly 104, then both the first rotor blade 102a and the second rotor blade 102b may rotate fifteen degrees relative to the first axis 150. Thus, the angle of attack (e.g., the angle relative to the first axis 150) may positive for a first rotor blade 102a and negative, but to the same degree, for the second rotor blade 102b.

The hub assembly 104 may connect the blade pair 102 to each other and to a vehicle (e.g., an AMV 101 illustrated in FIG. 2). The hub assembly 104 may further rotate along the second axis 151 and transfer rotational movement of the rotor mast 110 to the blade pair 102. This may generate thrust for rotor assembly 100. The hub assembly 104 may connect to a rotor mast 110 by a third coupling 103. The third coupling 103 may enable portions of the hub assembly 104 to rotate about the second axis 151 along with the rotor mast 110. In some examples, the third coupling 103 may be formed by, for example, an interior ring (e.g., the interior ring 230 as illustrated in FIG. 3C). The rotor mast 110 may extend and connect to a gearbox (not shown), for example via a drive shaft. The gearbox may be connected to a motor 160. The motor may be an electric motor.

The rotor mast 110 may be configured to rotate in response to commands from a user and/or a controller within the AMV 101, these commands being used to control motor 160 and/or an associated gearbox. The rotor mast 110 may be configured to further rotate portions of the swashplate (e.g., swashplate 220 as illustrated in FIG. 3A) as well as the blade pair 102.

FIG. 3A depicts a rotor assembly 200, according to one or more embodiments. Certain features of rotor assembly 200 may be similar to those of rotor assembly 100 discussed above with reference to FIG. 2.

The rotor assembly 200 may include a first blade 202a and a second blade 202b coupled to a rotor hub 204 (e.g., a rotor hub assembly) at a first coupling 205a and a second coupling 205b, respectively. In one example, the first blade 202a and second blade 202b may be located along the same axis or rotation (e.g., the first axis 150). The first blade 202a may be 180 degrees from the second blade 202b relative to the second axis 151. The first blade 202a may include an airfoil portion 209a and a connecting portion 207a. The airfoil portion 209a may be in the shape of an airfoil and may assist in generating lift when in contact with air. The connecting portion 207a may extend from the airfoil portion 209a and be located closest to the rotor hub 204. This connecting portion 207a may have a hollow interior capable of receiving a shaft 206 from the rotor hub 204 (also illustrated in FIG. 3C). This connecting portion 207a of the first blade 202a combined with the shaft 206 of the rotator hub 204 may form the first coupling 205a.

Similar to the first blade 202a, the second blade 202b may include an airfoil portion 209b and a connecting portion 207b. The airfoil portion 209b may be in the shape of an airfoil and may assist in generating lift when in contact with air. The connecting portion 207b may extend from the airfoil portion 209b and be located closest to the rotor hub 204. This connecting portion 207b may a hollow interior shape capable of receiving a shaft from the rotor hub 204 (as illustrated in FIG. 3C). This connecting portion 207b of the second blade 202b combined with the shaft of rotor hub 204 may form the second coupling 205b.

The connecting portion 207a, 207b may also receive shaft 206 shaft. The rotor assembly 200 may be for example a rigid rotor assembly. The shaft 206 may be received along the first axis 150. Further, each connecting portion 207a, 207b may include a plurality of through-holes 211a, 211b that extend through the connecting portions 207a, 207b. In one example, the connecting portions 207a, 207b may each have two through-holes 211a, 211b. In another example, the connecting portions 207a, 207b, may each have a single through-hole 211a, 211b. In further examples, the connecting portions 207a, 207b may have three or more through-holes 211a, 211b.

The through-holes 211a, 211b may be configured to receive fasteners 213a, 213b and secure the first blade 202a and second blade 202b to the shaft 206 of the rotor hub 204. In some examples, the through-holes 211a, 211b may be threaded. In other examples, the first coupling 105a and second coupling 105b, instead or in addition to threaded versions of the through-holes 211a, 211b, may include a plurality of nuts screwed to thread portions of bolts provided as the fasteners. In another example, clamps, adhesive, press fit, or additional attachment techniques known to one or ordinary skill in the art may be utilized to connect the first blade 202a and second blade 202b to the rotor hub 204. In examples where blades 202a and 202b are monolithically formed with each other and shaft 206 through-holes 211a, 211b may be omitted.

The rotor assembly 200 may further include a first yoke 212a and a second yoke 212b. The first yoke 212a and second yoke 212b may each be a respective shaft arm that extends from either a portion of the rotor mast 210 or from the hub assembly 104 (FIG. 2). In one example, the yokes 212a, 212b may be shaped to extend parallel to the rotor mast 210 for a first portion and then extend laterally outwards towards the respective first blade 202a and second blade 202b at an angle relative to the second axis 151 (as illustrated in FIG. 3C) for a second portion. The yoke 212a may extend outwards in the direction towards the first blade 202a. The yoke 212b may extend outwards in a direction towards the second blade 202b. The second portions of yokes 212a, 212b may be circular in a cross-sectional shape. The ends of the yokes 212a, 212b may extend past then the rotor mast 210 relative to the second axis 151. The yokes 212a, 212b may each include a respective head at an end furthest from the yokes 212a, 212b connection to the rotor mast 210. The heads of the yoke 212a, 212b may include apertures 215a, 215b capable of receiving the shaft 206. The apertures 215a, 215b may be aligned with the first axis 150.

The yokes 212a, 212b may include one or more bearings 262. The one or more bearings may be elastomeric bearings or ball bearings. The elastomeric bearings may be conical or tapered elastomeric bearings. In some embodiments, the elastomeric bearings may be spherical, cylindrical, or any other shape or configuration for bearings as would be known to one of ordinary skill in the art.

While groups of two yokes 212a, 212b are illustrated in FIG. 3A, a person of ordinary skill in the art would understand that groups of other numbers of yokes are envisioned. For example, if the hub assembly includes a third or fourth blade, an additional yoke may be included for each additional blade.

The rotor assembly may further include a linkage 250, the linkage 250 extending from a first end (e.g., a pitch link 216) to a second end (e.g., a control rod 218). The first end of the linkage 250 may be formed on a pitch link 216. The second end of the linkage 250 may be formed on a control rod 218. The linkage 250 may be configured to rotate the shaft 206 about the first axis 150. For example, vertical movement of the control rod 218 may move the pitch link 216 which may cause the shaft 206 to rotate along the first axis 150. As discussed, the rotation of the shaft may, through the first coupling 205a and second coupling 205b, increase and/or decrease an angle of attack of the first blade 202a and second blade 202b respectively.

The pitch link 216 may include a first end 217 that includes an aperture capable of receiving the shaft 206. The first end may 217 be generally cylindrical and include an aperture with a circular cross section when viewed along the first axis 150. The aperture of the first end 217 may include a lock-washer configured to provide a locking device for a nut holding the shaft 206 to the first end 217. In another example, the aperture of the first end 217 may be shaped to receive the shaft 206. In another example, the cross section of the aperture of the first end 217 may be ovular, rectangular or other geometric or non-geometric shapes. The first end 217 may be disposed between the two yokes 212a, 212b.

The first end 217 of the pitch link 216 may be coupled to the shaft 206. The first end 217 may include gears that may be located in between the coupling and be received by gear teeth (not shown) in shaft 206. This coupling may facilitate rotation of the shaft 206. The coupling may occur at roughly a center point along a length of the shaft 206. This may be the center-most point of the shaft 206. The center may be measured relative to and along the first axis 150. For example, the center of the shaft may be a point and/or area of the shaft of equal distance from the first blade 202a and the second blade 202b. In some embodiments, this coupling may be performed by a fastener such as a bolt or a clamp.

The pitch link 216 may extend from the first end 217 in a direction perpendicular to the first axis 150. The extension of the pitch link 216 from the first end 217 to a second end 219 may include a single arm 221. The single arm 221 may connect to the first end 217 at an axial center point of the shaft 206. The point of contact between the single arm 221 and the first end 217 may be generally radial or curved to match the shape of the shaft 206 and to avoid the accumulation of stress at the convergence point of first end 217 and first arm 221.

Further, in one example, the single arm 221, may include a second arm 221a and a third arm (not shown) that extend from a midpoint of the single arm 221 and couple to opposite axial sides of the first end 217. In other examples, multiple arms may connect from the first end 217 to the second end 219 of the pitch link 216. In another example, only a single arm 221 may be included within the pitch link 216.

The second end 219 of the pitch link 216 may be coupled to a control rod 218. The movement of the control rod 218 (e.g., as the control rod 218 is lifted or lowered by the swashplate 220) may move the second end 219 of the pitch link 216 in a pivoting motion relative to the first axis 150. This radial movement of the second end 219, may cause the first end 217 of the pitch link to rotate around the first axis 150.

The control rod 218 may have a first end 223 and a second end 225. The first end 223 of the control rod 218 may be coupled to the second end 219 of the pitch link 216. The first end 223 of the control rod 218 may be shaped as a prong. Each tip of the prong may have an aperture. A rod may extend though the each tip of the prong, as well as an aperture of second end 219 of the pitch link 216. This may form a semi rigid connection between the pitch link 216 and the control rod 218. The first end 223 of the control rod 218 may be connected to the second end 225 by one or more rods (e.g., a first rod 224a and a second rod 224b). The first rod 224a and second rod 224b may be separated by an opening 226. The length of the opening between the first rod 224a and second rod 224b may decrease between the first end 223 and second end 225. The shape of the control rod 218 may be configured to allow for the control rod 218 to perform pitch change and drive link functions simultaneously.

The second end 225 of the control rod 218 may be coupled to a swashplate 220. This coupling may be performed by welding, bolts, clamps, a press fit, or any other attachment method known to one of ordinary skill in the art.

The swashplate 220 may include an interior ring 230, a stationary ring 234, an exterior ring 232 (e.g., a rotating ring), and a tilt ball connection 236 configured to couple the stationary ring 234 and the exterior ring 232. The swashplate 220 may include one or more couplings capable of connecting the swashplate 220 to an actuator. For example, the swashplate 220 may have an actuator prong 238 (e.g., a link) capable of being coupled to an actuator. In another example, the swashplate 220 may have two actuator couplings (e.g., a first coupling 338 and a second coupling 340 as illustrated in FIG. 4). The actuator prong 238 may be prong shaped and have two separate flanges that extend from the swashplate 220 in a direction opposite of the rotor hub 204. In one example, the two separate flanges may extend in a direction away from the swashplate 220 at roughly a 45-degree angle relative to the swashplate 220 surface. The two separate flanges of the actuator prong 238 may each include an aperture at an end opposite of the connection to the swashplate 220. The aperture may be configured to receive a bolt or connecting element capable of coupling the actuator prong 238 to an actuator. In another example, the shape of the actuator prong 238 may have a single flange or various other shapes configured to receive an actuator. The actuator prong 238 may connect to the swashplate 220 at the stationary ring 234.

The swashplate 220 may be located below the control rod 218. The interior ring 230 of the swashplate may be annular in shape. The interior ring 230 may be aligned so the opening within the cylinder is aligned with the second axis 151. The interior ring may be non-rotating. The interior ring 230 may further be coupled to and circumferentially surround a portion of the rotor mast 210 (as shown in FIG. 3D). In another example, the interior ring 230 may surround both a rotor mast 210 and also a tilt ball (e.g., tilt ball 346 as illustrated in FIG. 4). The interior ring 230 may be configured to rotate with the rotor mast 210. The interior ring 230 may further include a flange that extends radially from the interior ring 230. This lip may be located at an end furthest from the rotor hub 204. The lip may include apertures spaced out along the lip. The interior ring 230 may also include a portion (e.g., connecting element 237 as illustrated in FIG. 3D) that connects the interior ring 230 to the stationary ring 234 and/or exterior ring 232.

The stationary ring 234 of swashplate 220 may be located radially outwards from the interior ring 230. The stationary ring 234 of swashplate 220 may be configured to remain rotationally-stationary while rotor mast 210 rotates. The stationary ring 234 may for example, include an anti-rotation link to prevent the stationary ring 234 from rotating. The stationary ring 234 may be configured to tilt relative to the second axis 151. Further, the stationary ring 234 may be configured to move (e.g., translate) upwards and downwards. The stationary ring 234 may connected to one or more actuator prongs (e.g., the actuator prong 238). In another example, the stationary ring 234 may include two actuator prongs located 90 degrees circumferentially apparat relative to the second axis 151. The stationary ring 234 may be configured to tilt the swashplate 220 in response to the couplings to the actuators. The stationary ring 234 may be coupled to the exterior ring 232 (e.g., the rotating swashplate) by a tilt ball connection 236.

The exterior ring 232 may be generally annular with an opening aligned with the second axis 151. A portion of the exterior ring 232 may extend as a semi-circle outside of the traditional ring shape. This external semi-circle may include a coupling for connecting the exterior ring 232 to the second end 225 of the control rod 218. This coupling may include as an aperture or recess, configured to accommodate a fastener that secures a respective end of the control rod 218 (e.g., the second end 225 of the control rod 218).

The tilt ball connection 236 may include bearings. The bearing may be ball bearings, spherical bearings, or any bearing known to one of ordinary skill in the art to allow for relative motion of the swashplate to the rotor mast. The tilt ball connection 236 may be located between the exterior ring 232 and stationary ring 234. The tilt ball connection 236 may allow for both the exterior ring 232 and the stationary ring 234 to tilt in unison while the exterior ring 232 rotates and the stationary ring 234 does not rotate.

The swashplate 220 may be configured to tilt relative the second axis 151 as a unit. For example, movement of the stationary ring 234 may, through the connection to the exterior ring 232, move the entire swashplate 220. This tilting may then cause movement of the pitch link 216 and control rod 218.

The swashplate 220 may be configured to cause movement of both the pitch link 216 and control rod 218, thus causing a rotation of shaft 206 along the first axis 150. Swashplate 220 may be configured to move as a result of a linear or rotational actuator as will be described in greater detail below. The swashplate 220 may be located below the control rod 218 and be configured to perform cyclic pitch control of both the first blade 202a and second blade 202b.

FIG. 3B depicts an overhead view of the rotor assembly of FIG. 2, according to one or more embodiments.

In an example, the pitch link 216 may extend from the control rod 218 along a single arm 221. The arm 221 may increase in width as in a direction toward the first end 217.

FIG. 3C depicts a cross-sectional view of the rotor assembly of FIG. 2, from a plane corresponding to line 3C-3C of FIG. 3B. As shown in FIG. 3C, the shaft 206 may extend from the first blade 202a to the second blade 202b. The shaft 206 may be may be a solid or a hollow shaft. The shaft may include, but is not limited to, the following materials of aluminum, titanium, steel, or a composite of those materials. The cross section of the shaft 206 may be for example circular, ovular, or rectangular. Shaft 206 may pass through one or more yoke protrusions (e.g., yoke 212a and yoke 212b).

The first blade 202a and second blade 202b may be coupled to the shaft 206 in a tilted configuration when the shaft is not rotated. If the first blade 202a may be set to a particular position, such as “X” degrees clockwise relative to the shaft 206, the second blade 202b may also be set to this position (or “X” degrees), but counter clockwise relative to the shaft. In one example, if the first blade 202a is set 5 degrees clockwise relative to the shaft 206, the second blade 202b may also be set to 5 degrees counter clockwise relative to the shaft 206. The first blade 202a and second blade 202b may, as discussed in greater detail below, may rotate simultaneously based on the shaft's 206 rotation.

The rotor mast 210 may further include the hollow chamber 228 that extends along the second axis 151. A gap 246 may exist between the end of the rotor mast 210 furthest from the AMV 101 and the shaft 206.

FIG. 3D depicts a cross-sectional view of the swashplate assembly of FIG. 2, from a plane corresponding to line 2A-2A of FIG. 3B. The interior ring 230 may include a portion that extends perpendicular to the interior ring 230 as two flanges to receive the other components of the swashplate 220 (e.g., the stationary ring 234). The connection between the interior ring 230 and the stationary ring 234 may include bearings or tilt ball connection 241 and a connecting element 237. The bearings may be ball bearings, spherical bearings, or any bearing known to one of ordinary skill in the art to allow for relative motion of the swashplate to the rotor mast.

Further, the stationary ring 234 and the exterior ring 232 (not shown) may be coupled by bearings (not shown). The stationary ring 234 may be capable of receiving a connection to one or more actuators. The exterior ring 232 (not shown) may include connections to a control rod and pitch link (e.g., the control rod 218 and pitch link 216).

FIG. 4 depicts an exemplary rotor assembly, according to one or more embodiments. Certain features of rotor assembly 300 may be similar to those of exemplary hub assembly discussed above with reference to FIGS. 3A-3C.

Discussion of similar features will be omitted.

The rotor assembly 300 may include a swashplate 320. The swashplate 320 may include one or more extensions to couple actuators to the swashplate 320. For example, the swashplate 320 may include a first coupling 338 and a second coupling 340. The first coupling 338 may include a prong that extends from the swashplate 320. The prong may extend from a stationary ring (e.g., the stationary ring 234 illustrated in FIG. 3A-3C) of the swashplate 320. The prong may have two separate flanges that extend from the swashplate 320 in a direction opposite of the rotor hub 204 (shown in FIG. 3A). In one example, the two separate flanges may extend in a direction away from the swashplate 320 at roughly a 45 degree angle relative to the swashplate 320 surface. The two separate flanges of the prong may each include an aperture at an end opposite of the connection to the swashplate 320. The aperture may be configured to receive a bolt or connecting element capable of connecting the flanges to an actuator and thus performing the first coupling 338. In another example, the shape of the actuator prong may have a single flange or various other shapes configured to receive an actuator. The second coupling 340 may have the same or similar components as the first coupling 338, but me used to connect a second actuator (e.g., second actuator 309) to the swashplate 320.

The swashplate 320 may be configured to rotate around tilt ball 346. The first coupling 338 and the second coupling 340 may located circumferentially 90 degrees apart from one another relative to the second axis 151.

The first coupling 338 and the second coupling 340 may be configured to transmit movements of the actuator (e.g., the first actuator 308 and second actuator 309) to the hub to facilitate cyclic pitch control of the rotor blades (e.g., the first rotor blade 302a and the second rotor blade 302b).

The first actuator 308 may connect to the first coupling 338. In one example, a rod may extend from the first actuator 308 towards the first coupling 338 and be connected utilizing a bolt or fastener.

The second actuator 309 may connect to the second coupling 340. In one example, a rod may extend from the second actuator 309 towards the second coupling 340 and be connected utilizing a bolt or fastener.

In some examples, the first actuator 308 and second actuator 309 may include a hydraulic actuator. The first actuator 308 and second actuator 309 may be capable of receiving a signal (e.g., from manually-operated cyclic controls and/or a controller) and in response to the signal, converting a source energy into a mechanical motion. For example, the motion may be linear and move the respective coupling (e.g., the first coupling 338, e.g., the second coupling 340) in a linear motion. This linear motion may be towards and away from the swashplate 320. In other examples, the first actuator 308 and second actuator 309 may include similar components, and operate in a similar fashion, as a solenoid. In still other examples, the actuator may include a pneumatic actuator. The first actuator 308 and second actuator 309 may be linear or rotational actuators.

In another example, the swashplate 320 may include additional couplings and actuators. For example, the swashplate 320 may include only a single actuator coupling and actuator. In another example, the swashplate 320 may include four actuator couplings and actuators. Rotor assembly 300 may only include more than one actuators to achieve different orientations then if only a single actuator was connected. For example, if only a single actuator existed, the swashplate 320 could only tilt along a single axis. Two or more actuators may allow for the swashplate 320 to tile along a plane rather than a single axis.

The first actuators 308 and second actuator 309 may have respective second ends 342, 344 opposite that of couplings 338 and 340. The second ends 342, 344 may extend from the body of the actuator away from the swashplate 320. The second ends 342, 344 may connect to for example cyclic controls of the AMV 101.

### Operation

Reference will now be made to the operation of the hub assemblies (e.g., 100, 200, and 300) described in FIG. 1-4.

While in flight within an AMV 101 or during takeoff or landing, a user and/or controller (e.g., an autopilot or other flight-control system) may adjust the cyclic controls of the AMV 101. In response to a cyclic controls being adjusted, an actuator (e.g., first actuator 308 and second actuator 309) may tilt a stationary ring (e.g., stationary ring 234) of the swashplate 320. As the rotor assembly may include two actuators, the swashplate 320 may be capable of tilting in a full range of motion relative to an axis (e.g., the second axis 151). As the stationary ring tilts, the bearing between the stationary ring and a rotating swashplate (e.g., exterior ring 232) may also tilt at the same angle as the stationary ring. This tilting may then move first the control rod 318 and then the pitch link 316. The movement of the pitch link 316 may cause a rotation of the shaft (e.g., shaft 206) along an axis (e.g., the first axis 150). As the shaft is connected to blades (e.g., a first rotor blade 302a and a second rotor blade 302b), the blades may rotate correspondingly to the shaft. Both blades may rotate and change an angle of attack simultaneously. The pitch link 316 may further be the driving force that causes the shaft and blades to rotate around the second axis 151, causing the lift force of the rotor assembly. As the shaft rotates around the second axis 151, the control rod (e.g., control rod 318) may move upwards and downwards according to the tilt of the swashplate (e.g., swashplate 320) with respect to the second axis 151. This may cause the blades (e.g., the first blade 302a and second blade 302b) to change angle throughout a single rotation of the blades around the second axis 151. The change in angle of one blade may correspond to the change of angle in the other blade as both blades are connected by the single shaft 206.

During operation of the AMV, blades (e.g., the first blade 202a and second blade 202b) may be rotated about the first axis 150 and about the second axis 151 to account for and control changes in airspeed. An advancing blade (e.g., moving against airflow) may decrease an angle of attack (e.g., an angle relative to the first axis 150) when an airspeed against the AMV increases (e.g., airflow increases with higher windspeed or as the vehicle moves) to maintain a determined level of vertical thrust. The advancing blade may increase an angle of attack when an airspeed against the vehicle decreases. A retreating blade (e.g., moving with airflow) may decrease an angle of attack when an airspeed against the vehicle increases (e.g., airflow increases with higher windspeed or as the vehicle moves) to maintain a determined level of vertical thrust. Alternatively, the retreating blade may decrease an angle of attack when an airspeed against the vehicle decreases. The determined level of thrust may be based on a selected thrust, wherein the selected thrust may be higher to create lift (e.g., gain altitude), lower to decrease lift (e.g., lose altitude), or at a level to maintain lift (e.g., maintain an altitude).

During operation of the AMV, a first rotor assembly and a second rotor assembly may operate and respond to cyclic controls independently or in unison. Both the first and second rotor may correspond to any of the rotor assemblies 100, 200, or 300 described herein. A first rotor assembly may include: a first set of at least two blades; a first shaft connecting the first set of at least two blades; a first pitch link connected to the first shaft and configured to change an angle of attack of the first set of at least two blades. A second rotor assembly may include a second set of at least two blades; a second shaft connecting the second set of at least two blades; and a second pitch link connected to the second shaft and configured to change an angle of attack of the second set of at least two blades. Both the first rotor and second rotor assembly may operate independently as described above.

In some embodiments, blades (e.g., the first blade 202a and second blade 202b) may be rotated every revolution around the second axis 151. In some embodiments, an actuator configured to act on pitch link 216 and/or control rod 218 may affect an oscillating setting of blades.

In some embodiments, where a vehicle comprises more than one rotor hub assembly, an oscillation stress on the vehicle caused by lift disparity of different forces on different rotor hub assemblies can be reduced by actuating a swashplate of one or more rotor hub assemblies.

Rotor assemblies consistent with disclosed embodiments may be connected to fixed speed or variable speed motors. In some embodiments, where rotor assemblies are connected to variable speed motors, thrust may be adjusted to maneuver a vehicle (e.g., different speeds for different rotors/rotor assemblies of a vehicle to change a direction of travel). In some embodiments, an electric motor can be used as a variable speed motor to power or move disclosed rotor assemblies.

One or more embodiments may include a hub assembly that utilizes less components, the less components leading to a reduction in weight and space requirements along with drag. Reduced weight of the hub assembly may further reduce vibrations to a motor mast.

One or more embodiments has an ability to efficiently adjust an angle attack of the blades. For example, corresponding angle of attack changes of blade may lead to more accurate cyclic controls. The system may be capable of adjusting the corresponding angles of attack of blades using a single pitch link and control rod. Each blade may not require a separate pitch link.

Throughout this disclosure, references to components or modules generally refer to items that logically can be grouped together to perform a function or group of related functions. Like reference numerals are generally intended to refer to the same or similar components. Components and modules may be implemented in software, hardware or a combination of software and hardware.

The tools, modules, and functions described above, including the controller, may be performed by one or more processors.

It will be apparent to persons skilled in the art that various modifications and variations can be made to the disclosed structure. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present invention. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. A rotor assembly comprising:
a rotor mast connected to a motor and to a rotor hub, the rotor mast being rotatable about a first axis;
a plurality of blades connected to the rotor hub;
the rotor hub including a shaft connecting the blades, the shaft being rotatable about a second axis;
a swashplate connected to the rotor mast and to the shaft; and
a single linkage extending from a first end to a second end, the first end being coupled to the shaft, the second end being coupled to the swashplate, the single linkage configured to transfer motion of the swashplate to rotation of the shaft about the second axis and thereby rotate the blades about the second axis simultaneously.

2. The rotor assembly of claim 1, wherein the first end of the single linkage is formed on a pitch link and the second end of the single linkage is formed on a control rod.

3. The rotor assembly of claim 2, wherein the pitch link is coupled to the shaft at a center-most point of the shaft.

4. The rotor assembly of claim 2, wherein a first end of the pitch link is generally cylindrical and includes an aperture configured to receive the shaft, wherein the first end of the pitch link forms the first end of the single linkage.

5. The rotor assembly of claim 4, wherein a second end of the pitch link, opposite of the first end of the pitch link, is coupled to the control rod, wherein the second end of the pitch link is configured to pivot when lifted or lowered by the control rod.

6. The rotor assembly of claim 1, wherein the shaft is configured to decrease a first angle of attack of a first blade and increase a second angle of attack of a second blade simultaneously.

7. The rotor assembly of claim 1, wherein the shaft is connected to the rotor mast by two yoke protrusions, the first end of the single linkage being disposed between the two yoke protrusions.

8. A rotor assembly comprising:
a rotor mast connecting a motor to a rotor hub, the rotor mast being rotatable about a first axis that extends through the rotor mast;
at least two blades connected to the rotor hub;
a shaft connecting the at least two blades, the shaft being rotatable about a second axis;
a control rod;
a swashplate connected to the shaft by the control rod; and
a pitch link connected to the shaft at a center of the shaft as measured along the second axis, the pitch link being configured to rotate the shaft around the second axis and thereby change an angle of attack of the at least two blades simultaneously.

9. The rotor assembly of claim 8, wherein the shaft is a single shaft that passes through a center of the rotor assembly as measured along the second axis.

10. The rotor assembly of claim 9, wherein the control rod is connected to the shaft by the pitch link.

11. The rotor assembly of claim 9, wherein a first end of the pitch link is generally cylindrical and includes an aperture configured to receive the shaft.

12. The rotor assembly of claim 11, wherein the pitch link extends towards the control rod in a direction perpendicular to the second axis.

13. The rotor assembly of claim 8, wherein the shaft is connected to the rotor hub by two yoke protrusions.

14. The rotor assembly of claim 13, wherein the pitch link is disposed between the two yoke protrusions.

15. A vehicle comprising:
a first rotor assembly comprising:
a first set of at least two blades;
a first shaft connected to the first set of at least two blades, the first shaft being rotatable about a first axis; and
a first pitch link connected to the first shaft at a center of the first shaft as measured along the first axis and configured to rotate the first shaft along the first axis and thereby change an angle of attack of the first set of at least two blades; and
a second rotor assembly comprising:
a second set of at least two blades;
a second shaft connected to the second set of at least two blades, the
second shaft being rotatable about a second axis; and
a second pitch link connected to the second shaft at a center of the second shaft as measured along the second axis and configured to rotate the second shaft along the second axis and thereby change an angle of attack of the second set of at least two blades.

16. The vehicle of claim 15, wherein the first rotor assembly includes a first swashplate connected to the first shaft by a first control rod, and the second rotor assembly includes a second swashplate connected to the second shaft by a second control rod.

17. The vehicle of claim 16, wherein the first control rod is connected to the first shaft by the first pitch link, and the second control rod is connected to the second shaft by the second pitch link.

18. The vehicle of claim 16, wherein a first end of the first pitch link defines a cylindrical aperture configured to receive the first shaft, wherein a first end of the second pitch link defines a cylindrical aperture configured to receive the second shaft.

19. The vehicle of claim 16, wherein the first set of at least two blades are configured to be rotated by the connection to the first swashplate every revolution and the second set of at least two blades are rotated by the connection to the second swashplate every revolution.

20. The vehicle of claim 15, wherein the first shaft is configured to decrease a first angle of attack of a first blade of the first set of at least two blades and increase a second angle of attack of a second blade of the first set of at least two blades simultaneously; and the second shaft is configured to decrease a third angle of attack of a third blade of the second set of at least two blades and increase a fourth angle of attack of a fourth blade of the second set of at least two blades simultaneously.
